(19) United States
(12) Patent Application Publication
(10) Pub. No.: US 2002/0048424 A1
(43) Pub. Date: Apr. 25, 2002

(54) Comb filter for dense wavelength division multiplexing

(76) Inventor: Bin Zhao, Irvine, CA (US)

Correspondence Address: STRADLING YOCCA CARLSON & RAUTH, IP Department, P.O. Box 7680, 660 Newport Center Drive, Suite 1600, Newport Beach, CA, 92660-6441, US

(21) Appl. No.: 09/876,819

(22) Filed: Jun. 7, 2001

Related U.S. Application Data
(60) Provisional application No. 60/210,033, filed on Jun. 7, 2000.

(51) Int. Cl. G02B 6/27; G02B 27/28

(52) U.S. Cl. 385/11; 359/495

(57) ABSTRACT

A comb filter has a input polarization beam separation element, a birefringent filter assembly in optical communication with the input polarization beam separation element, and an output polarization beam separation and combination element assembly in optical communication with the birefringent filter assembly. The birefringent filter assembly comprises at least one birefringent filter stage, wherein each birefringent filter stage preferably comprises a polarization beam splitter and two reflectors.

### CROSS-REFERENCE TO RELATED APPLICATIONS

This patent application claims the benefit of the filing date of U.S Provisional Patent Application Ser. No. 60/210,033, filed on Jun. 7, 2000 and entitled HIGH PERFORMANCE INTERLEAVER FOR OPTICAL COMMUNICATIONS, the entire contents of which are hereby expressly incorporated by reference.

This patent application is related to co-pending patent application Ser. number ______, filed on Jun. 7, 2001 entitled LOW CROSSTALK FLAT BAND FILTER (Docket No. 12569-01); co-pending patent application Ser. No. ______, filed on Jun. 7, 2001 entitled BIREFRINGENT DEVICES (Docket No. 12569-02); co-pending patent application Ser. No. ______, filed on Jun. 7, 2001 entitled INTERLEAVER USING SPATIAL BIREFRINGENT ELEMENTS (Docket No. 12569-03); co-pending patent application Ser. No. ______, filed on Jun. 7, 2001 entitled APPARATUS AND METHOD FOR LOW DISPERSION IN COMMUNICATIONS (Docket No. 12596-13); all filed on the instant date herewith and commonly owned by the Assignee of this patent application, the entire contents of all which are hereby expressly incorporated by reference.

### FIELD OF THE INVENTION

The present invention relates generally to optical devices and relates more particularly to a high performance filter or interleaver for optical communications and the like.

### BACKGROUND OF THE INVENTION

Optical communication systems which utilize wavelength-division multiplexing (WDM) and dense wavelength-division multiplexing (DWDM) technologies are well known. According to both wavelength-division multiplexing and dense wavelength-division multiplexing, a plurality of different wavelengths of light, preferably infrared light, are transmitted via a single medium such as an optical fiber. Each wavelength corresponds to a separate channel and carries information generally independently with respect to the other channels. The plurality of wavelengths (and consequently the corresponding plurality of channels) are transmitted simultaneously without interference with one another, so as to substantially enhance the transmission bandwidth of the communication system. Thus, according to wavelength-division multiplexing and dense wavelength-division multiplexing technologies, a much greater amount of information can be transmitted than is possible utilizing a single wavelength optical communication system.

The individual channels of a wavelength-division multiplexed or dense wavelength-division multiplexed signal must be selected or separated from one another at a receiver in order to facilitate detection and demodulation thereof. This separation or demultiplexing process can be performed or assisted by an interleaver. A similar device facilitates multiplexing of the individual channels by a transmitter.

It is important that the interleaver separate the individual channels sufficiently so as to mitigate undesirable crosstalk therebetween. Crosstalk occurs when channels overlap, i.e., remain substantially unseparated, such that some portion of one or more non-selected channels remains in combination with a selected channel. As those skilled in the art will appreciate, such crosstalk interferes with the detection and/or demodulation process. Generally, the effects of crosstalk must be compensated for by undesirably increasing channel spacing and/or reducing the communication speed, so as to facilitate reliable detection/demodulation of the signal.

However, as channel usage inherently increases over time, the need for efficient utilization of available bandwidth becomes more important. Therefore, it is highly undesirable to increase channel spacing and/or to reduce communication speed in order to compensate for the effects of crosstalk. Moreover, it is generally desirable to decrease channel spacing and to increase communication speed so as to facilitate the communication of a greater quantity of information utilizing a given bandwidth.

Modern dense wavelength-division multiplexed (DWDM) optical communications and the like require that network systems offer an ever-increasing number of channel counts, thus mandating the use of a narrower channel spacing in order to accommodate the increasing number of channel counts. The optical interleaver, which multiplexes and demultiplexes optical channels with respect to the physical media, i.e., optical fiber, offers a potential upgrade path, so as to facilitate scalability in both channel spacing and number of channel counts in a manner which enhances the performance of optical communication networks.

As a multiplexer, an interleaver can combine two streams of optical signals, wherein one stream contains odd channels and the other stream contains even channels, into a single, more densely spaced optical signal stream. As a demultiplexer, an interleaver can separate a dense signal stream into two, wider spaced streams, wherein one stream contains the odd channels and the other stream contains the even channels. Thus, the interleaver offers scalability which allows contemporary communication technologies that perform well at wider channel spacing to address narrower, more bandwidth efficient, channel spacings.

There are four basic types of interleavers suitable for multiplexing and demultiplexing optical signals. These include birefringent filters, thin-film dielectric devices, planar waveguides, and fiber-based devices. All of these contemporary interleaving technologies suffer from substantial limitations with respect to channel spacing, dispersion, insertion loss, channel isolation, temperature stability, cost, reliability and flexibility. For example, most commercially available interleavers provide only 100 GHz and 50 GHz channel spacings. Reduction of channel spacing to 25 GHz, 12.5 GHz and beyond appears to be difficult and challenging.

Thus, there is a need to provide an optical interleaver which can overcome or mitigate at least some of the above-mentioned limitations.

### SUMMARY OF THE INVENTION

The present inventions specifically addresses and alleviates the above-mentioned deficiencies associated with the prior art. More particularly, one embodiment of the present invention comprises an interleaver comprising an input polarization beam separation element, a birefringent filter assembly in optical communication with the input polarization beam separation element, and an output polarization beam separation/combination element assembly in optical communication with the birefringent filter assembly. The birefringent filter assembly comprises at least one birefringent filter stage.

According to the present invention birefringent crystals, such as those commonly used in contemporary birefringent filters, are eliminated, so as to mitigate at least some of the problems associated with prior art interleavers. Rather than using birefringent crystals, the interleaver of the present invention utilizes a device which provides optical paths having different optical path lengths for two orthogonally polarized light beams, so as to provide a birefringent effect.

These, as well as other advantages of the present invention, will be more apparent from the following description and drawings. It is understood that changes in the specific structure shown and described may be made within the scope of the claims without departing from the spirit of the invention.

### BRIEF DESCRIPTION OF THE DRAWINGS

These, and other features, aspects and advantages of the present invention will be more fully understood when considered with respect to the following detailed description, appended claims and accompanying drawings, wherein:

FIG. 1 is a schematic diagram of a one-stage birefringent filter or interleaver utilizing mirrors according to the present invention;

FIG. 2 is a series of frames showing the optical beam states and the orientations of half-wave waveplates and quarter-wave waveplates at different locations in the one-stage interleaver of FIG. 1, wherein the underlined number associated with each frame shows the location where the optical beam state or waveplate orientation occurs in FIG. 1;

FIG. 3 is a schematic diagram of a two-stage birefringent filter or interleaver utilizing mirrors according to the present invention;

FIG. 4 is a series of frames showing the optical beam states and the orientations of half-wave waveplates and quarter-wave waveplates at different locations in the two-stage interleaver of FIG. 3, wherein the underlined number associated with each frame shows the location where the optical beam state or waveplate orientation occurs in FIG. 3;

FIG. 5 is a schematic diagram of a three-stage birefringent filter or interleaver utilizing mirrors according to the present invention;

FIG. 6 is a series of frames showing the optical beam states and the orientations of half-wave waveplates and quarter-wave waveplates at different locations in the three-stage interleaver of FIG. 5, wherein the underlined number associated with each frame shows the location where the optical beam state or waveplate orientation occurs in FIG. 5;

FIG. 7 is a schematic diagram of a three-stage birefringent filter or interleaver utilizing mirrors, showing an array of input and output optical beams;

FIG. 8 is a schematic diagram of a five-stage birefringent filter or interleaver utilizing mirrors, showing an array of input and output optical beams;

FIG. 9a is a schematic diagram showing an alternative layout or configuration for a three-stage birefringent filter or interleaver utilizing mirrors;

FIG. 9b is a schematic diagram showing an alternative layout or configuration for a five-stage birefringent filter or interleaver utilizing mirrors;

FIG. 10 is a schematic diagram of a one-stage birefringent filter or interleaver utilizing prisms according to the present invention;

FIG. 11 is a schematic diagram of a two-stage birefringent filter or interleaver utilizing prisms according to the present invention;

FIG. 12 is a schematic diagram of a three-stage birefringent filter or interleaver utilizing prisms according to the present invention;

FIG. 13 is a schematic diagram of a five-stage birefringent filter or interleaver utilizing prisms, showing an array of input and output optical beams;

14a is a schematic diagram showing an alternative layout or configuration for a three-stage birefringent filter or interleaver utilizing prisms; and

FIG. 14b is a schematic diagram showing an alternative layout or configuration for a five-stage birefringent filter or interleaver utilizing prisms.

### DETAILED DESCRIPTION OF THE INVENTION

The detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The description contained herein is directed primarily to the configuration of an interleaver as a demultiplexer. However, as those skilled in the art will appreciate, the present invention may be used in both demultiplexers and multiplexers. The difference between demultiplexers and multiplexers is small and the configuration of the present invention as either desired device is well within the ability of one of the ordinary skill in the art.

Two different reference systems are used in this patent application for the determination of angular orientations. One reference system is used for the determination of the angular orientations of birefringent elements, such as birefringent crystals, with respect to the polarization direction of input light. Another reference system is used for the determination of the angular orientations of birefringent elements and the angular orientations of waveplates with respect to a moving (x, y, z) coordinate system. Thus, for the birefringent element angular orientations, two separate reference systems are utilized. Thus, when reading the detailed description below, it will be very helpful to understand these two reference systems.

When the angular orientation of a birefringent element is discussed, the angular orientation is typically the fast axis of the birefringent element with respect to the polarization direction of incoming light just prior to the incoming light reaching the birefringent element. Determination of the angular orientation is made by observing oncoming light with the convention that the angle is positive if the rotation of the fast axis is clockwise with respect to the polarization direction of the oncoming light and is negative if the rotation is counter-clockwise with respect to the polarization direction of the oncoming light.

If there is a series of birefringent elements, such as in a birefringent filter, the angular orientations of each of the elements of the filter are measured by their fast axes with respect to the polarization direction of incoming light just prior to the incoming light reaching the first birefringent element of the filter. If there are more than one birefringent filters in a sequence, then the angular orientations are determined separately for each birefringent filter (the angular orientations are measured with respect to the polarization direction of incoming light just prior to the incoming light reaching the first birefringent element of each different filter). Thus, each birefringent filter has its own independent reference for the determination of the angular orientations of the birefringent elements thereof.

By the way of contract, the angular orientation of birefringent elements and angular orientations of waveplates are also measured by the fast axes of birefringent elements and the optic axes of waveplates with respect to the +x axis. However, it is very important to appreciate that the +x axis is part of the moving coordinate system. This coordinate system travels with the light, such that the light is always traveling in the +z direction and such that the +y axis is always up as shown in the drawings. Thus, when the light changes direction, the coordinate system rotates with the +y axis thereof so as to provide a new coordinate system. The use of such a moving coordinate system allows the optical beam states, the birefringent elements, and the waveplates to be viewed in a consistent manner at various locations in the devices, i.e., always looking into the light, and therefore substantially simplifies viewing and analysis of the devices.

Determination of the angular orientations in (x, y, z) coordinate system is made by observing oncoming light with the convention that the angle is positive if the rotation of the corresponding optical axis is counter-clockwise with respect to +x axis and is negative if the rotation is clockwise with respect to the +x axis (which is consistent the conventional use of (x, y, z) coordinate system, but which is contrary to the sign convention for determining the angular orientations of birefringent elements with respect to the input polarization direction, as discussed above).

As those skilled in the art will appreciate, an interleaver is an optical device which typically includes at least one birefringent filter. Further, a birefringent filter is one example of a comb filter.

More particularly, the present invention comprises an interleaver comprising an input polarization beam displacer, a birefringent filter assembly in optical communication with the input polarization beam displacer, a first output polarization beam displacer in optical communication with the birefringent filter assembly and a second output polarization beam displacer in optical communication with the first output polarization beam displacer. The birefringent filter assembly comprises at least one birefringent filter stage. Each birefringent filter stage comprises a polarization beam splitter and two reflectors.

The two reflectors may comprise either mirrors or etalons.

Each birefringent filter stage preferably further comprises a quarter-wave waveplate disposed intermediate each reflector and the polarization beam splitter. Preferably, the quarter-wave waveplate has an optical axis thereof oriented at 45° with respect to a +x axis at that location.

The interleaver further comprises a first input half-wave waveplate disposed intermediate the input polarization beam displacer and the birefringent filter assembly which is configured so as to transmit a non-displaced beam therethrough. The first input half-wave waveplate preferably has an optical axis thereof oriented at 22.5° with respect to the +x axis at that location. A second input half-wave waveplate is similarly disposed intermediate the input polarization beam displacer and the birefringent filter assembly and is configured so as to transmit a displaced beam therethrough. The second input half-wave waveplate preferably has an optical axis thereof oriented at −22.5° with respect to the +x axis at that location.

A half-wave waveplate is configured to receive an output of each polarization beam splitter.

A first output half-wave waveplate is disposed intermediate the first output polarization beam displacer and the second output polarization beam displacer. A second half-wave waveplate is disposed intermediate the first output polarization beam displacer. A third half-wave waveplate is disposed intermediate the first output polarization beam displacer and the second output polarization beam displacer. A fourth half-wave waveplate is disposed intermediate the first output polarization beam displacer. The positioning and operation of the first, second, third and fourth output half-wave waveplates is discussed in detail below.

The birefringent filter assembly may comprise any desired number of birefringent filter stages. As those skilled in the art will appreciate, the use of additional birefringent filter stages enhances the transmission versus wavelength curve, such that a more flat and wider passband is defined and such that a deeper and wider stopband is defined. Thus, for example, the birefringent filter assembly may comprise one, two, three, four, five or more stages, as desired.

Preferably, the input polarization beam displacer, the birefringent filter assembly, the first output polarization beam displacer and the second output polarization beam displacer are configured so as to facilitate interleaving of a plurality of beams simultaneously, preferably so as to facilitate interleaving of a plurality of arrayed beams simultaneously. Those skilled in the art will appreciate that various different configurations of arrays, e.g., two dimensional, square, rectangular, circular, oval, etc., may similarly be utilized.

Thus, the interleaver of the present invention comprises a birefringent filter assembly coupled to receive at least two beams of polarized light (such as two beams which are orthogonally polarized with respect to one another at the input). The birefringent filter assembly is configured so as to provide a birefringent effect with respect to the two beams, without the use of birefringent crystals. Rather, the birefringent filter assembly provides a birefringent effect with respect to the two beams by causing the two beams to travel along two different paths, wherein each path has a difference optical path length.

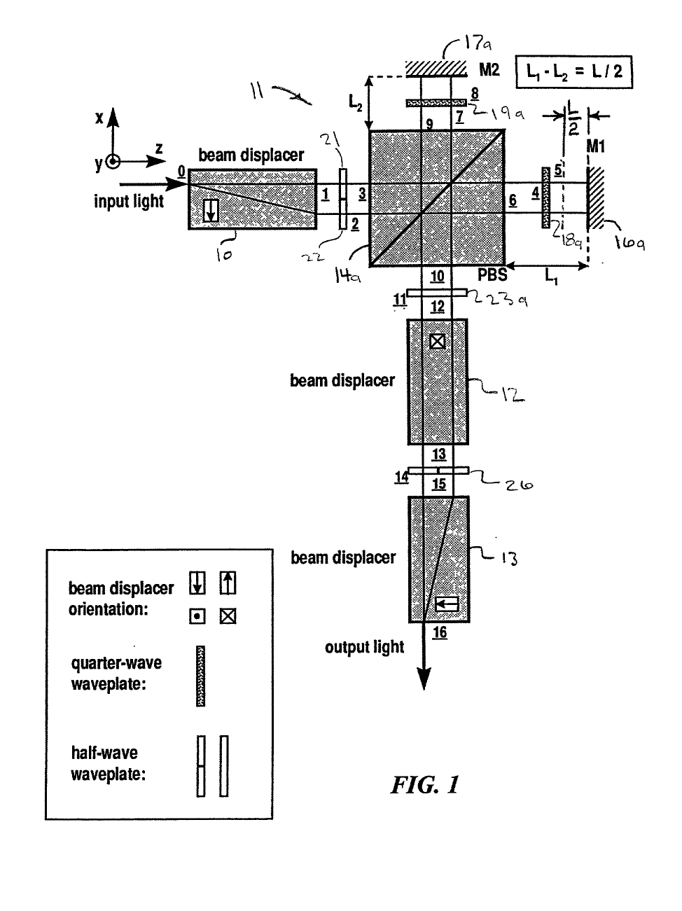

Referring now to FIG. 1, a one-stage optical interleaver comprises an input polarization beam displacer 10, a birefringent filter assembly 11 in optical communication with the input polarization beam displacer 10, a first output polarization beam displacer 12 in optical communication with the birefringent filter assembly 11, and a second output polarization beam displacer 13 in optical communication with the first output polarization beam displacer 12.

According to a first embodiment of the present invention, each stage of the birefringent filter assembly comprises a polarization beam splitter 14 and two reflectors, such as first 16 and second 17 mirrors.

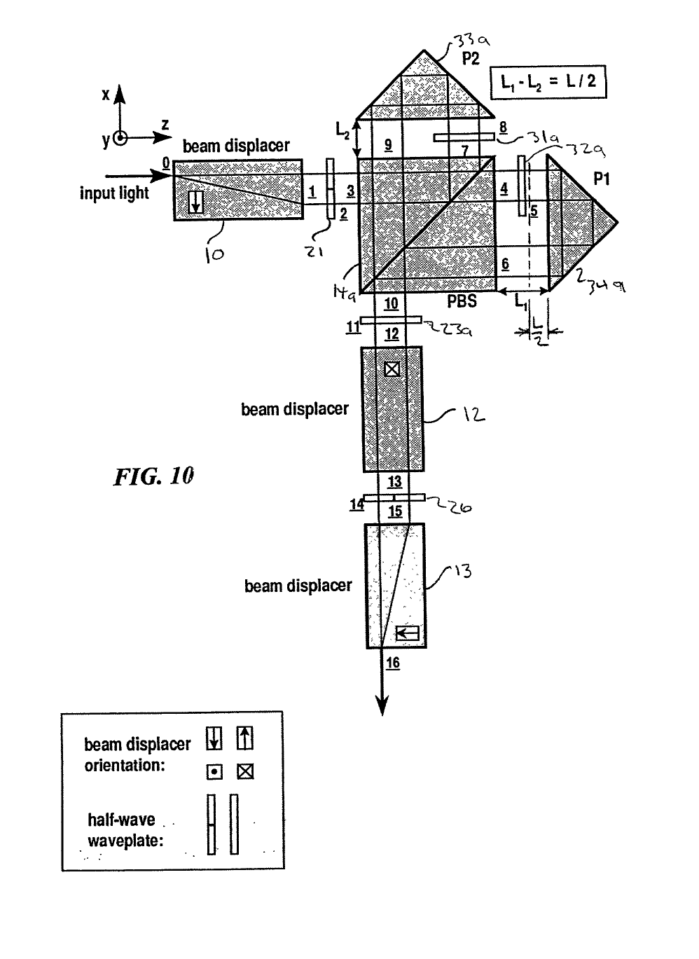

FIGS. 1, 3, 5, 7, 8, 9a and 9b show the first embodiment of the interleaver having various different numbers of birefringent filter stages. Similarly, FIGS. 10, 11, 12, 13, 14a and 14b show the second embodiment of the interleaver having various different numbers of birefringent filter stages. In each of FIGS. 1, 3, 5, 7, 8, 9a, 9b, 11, 12, 13, 14a and 14b, the components of the first birefringent filter stage have an “a” following the component number thereof, the components of the second birefringent filter stage have the letter “b” following the number of the component thereof and so on. Thus, like components within each different stage have the same number, but have a different letter which indicates which stage they are part of. For example, the polarization beam splitter is always number 14, regardless of which stage it is in, and is followed by the letter “a” (to form the reference number “14a”) when in the first stage and is followed by the letter “b” (to form the reference number “14b”) when in the second stage, and so on. When a component is referred to generically, i.e., without regard as to which specific stage the component is part of, then the letter may be omitted.

Preferably, each birefringent filter stage 11 further comprises a first quarter-wave waveplate 18 intermediate each first mirror 16 and the polarization splitter 14 and similarly comprises a second quarter-wave plate 19 between each second mirror 17 and the polarization beam splitter 14 thereof. Preferably, the optical axis of both the first 18 and the second 19 quarter-wave waveplates are oriented at approximately 45° with respect to the +x axis at that location.

Preferably, the interleaver comprises a first input half-wave waveplate 21 disposed intermediate the input polarization beam displacer 10 and the birefringent filter assembly 11 and configured so as to transmit the non-displaced beam therethrough and also further comprises a second input half-wave waveplate 22 disposed intermediate the input polarization beam displacer 10 and the birefringent filter assembly 11 and configured so as to transmit the displaced beam therethrough. The first input half-wave waveplate 21 preferably has an optical axis thereof oriented at approximately 22.5° with respect to the plane within which the +x axis at that location. The second input half-wave waveplate 22 has an optical axis thereof oriented at approximately −22.5° with respect to the +x axis at that location.

A half-wave waveplate 23 is configured to receive an output of each polarization of beam splitter 14. The half-wave waveplate 23 preferably has an optical axis oriented at an angle of −22.5° with respect to a +x axis at that location.

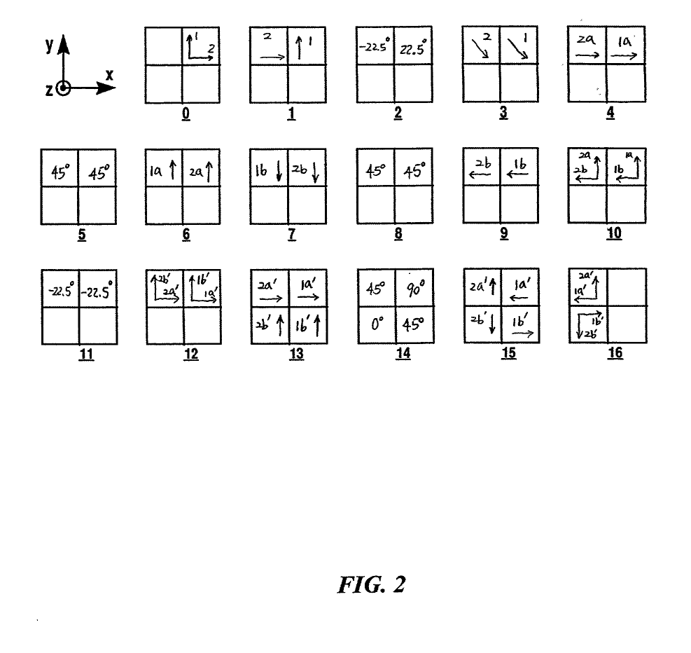

Four half-wave waveplates 26 are disposed intermediate the first output polarization beam displacer 12 and the second output polarization beam displacer 13. More particularly, a first half-wave waveplate, preferably having an optic axis orientation of approximately 45°; a second half-wave waveplate, preferably having an optic axis orientation of approximately 90°; a third half-wave waveplate, preferably having an optic axis orientation of 0°; and a fourth half-wave waveplate, preferably having an optic axis orientation of 45° are all disposed, preferably within a common plane, intermediate the first output beam displacer 12 and a second output beam displacer beam 13. The positions and the orientations of each of these half-wave waveplates 26 are shown in frame 14 of FIG. 2.

As discussed in detail below, the birefringent filter assembly 11 may comprise one birefringent filter stage, two birefringent filter stages, three birefringent filter stages, four birefringent filter stages, five birefringent filter stages or any other desired number birefringent filter stages.

FIG. 1 schematically shows an interleaver comprising a one stage birefringent filter assembly. A right-hand coordinate system of axes is used to characterize the optical beam propagation in the system at various locations utilizing the convention that light is always propagating in the +z direction and that the +y direction is out of the plane of the paper in FIG. 1. This convention applies to all of the figures discussed herein.

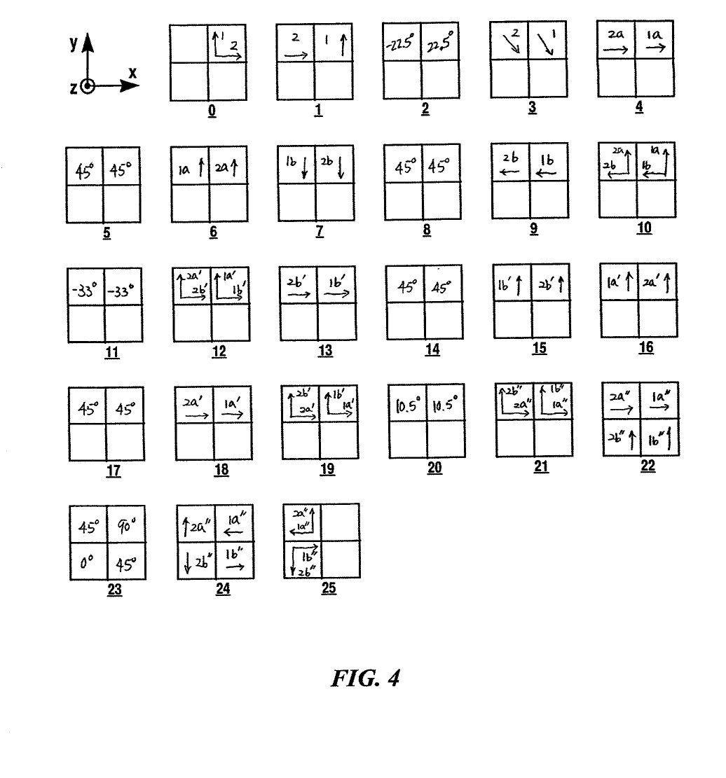

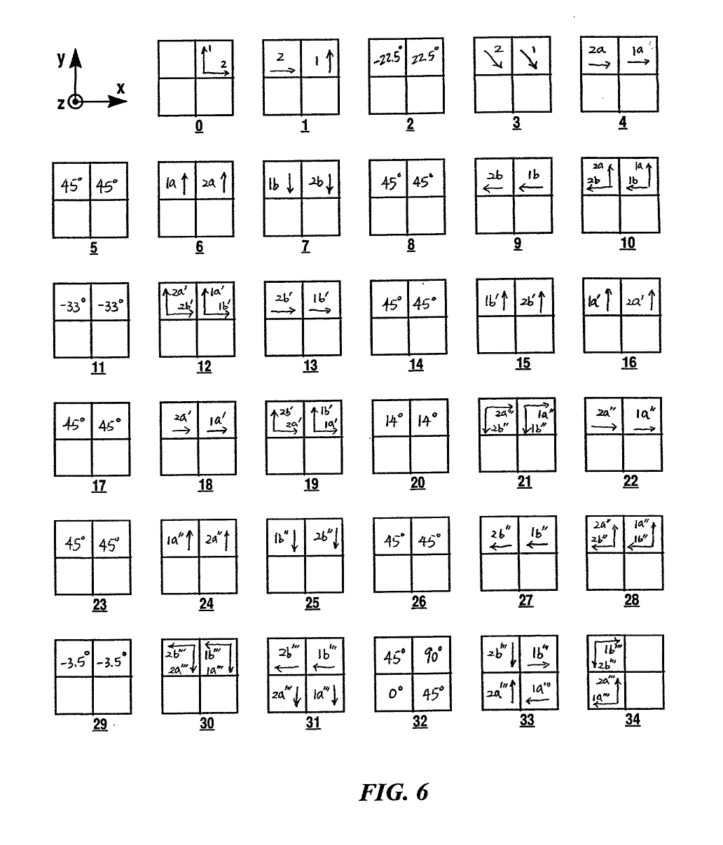

Referring now to FIG. 2, the optical beam states, the quarter-wave waveplate and the half-wave waveplate orientations at various locations are shown in a plurality of frames, wherein the underlined number associated with each frame corresponds to the location where the wave state or waveplate orientation occurs in FIG. 1. Each of the 4 boxes of a frame corresponds to a physical beam position at various locations. As those skilled in the art will appreciate, the beam displacers provide both horizontal and vertical displacement of the beam, resulting in the formation of four separate beams. Each box of a frame of FIG. 2 corresponds to one of these four beams when viewed as looking into oncoming light. This applies to the frames of FIGS. 4 and 6, as well.

At location 0, an input or composite optical beam has two linearly polarized components 1 along the y direction and 2 along the x direction, at the top-right box or beam position. After the beam propagates through the first polarization beam displacer at location 1, the component 2 shifts to the top-left beam position and component 1 remains at the top-right beam position.

The arrows shown on the polarization beam displacers on FIG. 1 indicate the beam shift direction for the polarization beam displacers of FIG. 1. After components 1 and 2, respectively, pass through the half-wave waveplates 21 at location 2, the linearly polarized components 1 and 2 are polarized along the same direction, i.e., −45° with respect to the +x axis at location 3. At location 2, the optical axis of the half-wave waveplate for component 1 is oriented at 22.5° with respect to the +x axis and the optical axis of the half-wave waveplate for component 2 is oriented at −22.5° with respect to the +x axis.

When component 1 enters the polarization beam splitter, component 1 splits into two beams according to the optical field polarization direction of each. The input optical component polarized in the x direction (1a) propagates along its original propagation to location 4. At location 5, the quarter-wave waveplate 18a is oriented at 45° with respect to +x axis. After component 1a passes through the quarter-wave waveplate 18a, it is reflected by etalon or mirror 16a and passes through the quarter-wave waveplate 18a again. Its polarization direction is changed from the x direction to the y direction at location 6.

The input optical component polarized in the y direction (1b) is deflected by the polarization beam splitter and propagates in a direction orthogonal to the input beam propagation direction to location 7. The quarter-wave waveplate 19a at location 8 is oriented at 45° with respect to the +x axis. The polarization direction of the component 1b is changed from the y direction to the x direction when it travels back to location 9. Components 1a and 1b are combined at location 10.

It is worthwhile to understand that the distance L₁ between the polarization beam splitter 14a and the first mirror 16a is different from the distance L₂ between the polarization splitter 14a and the second mirror 17a. Thus, there is a phase difference r in component 1a and component 1b at location 10, as represented by the equation:

Γ=2·(L₁−L₂)·2π/λ=L·2π/λ

where λ is the optical wavelength. Component 2 (which becomes split into components 2a and 2b) propagates in a similar manner. The beam positions for components 1 and 2 are exchanged at location 10 due to deflection by the polarization beam splitter 14a.

Components and 1 and 2 pass through half-wave waveplate 23a at location 11. Half-wave waveplate 23a is oriented at −22.5° with respect to +x axis. Half-wave waveplate 23a changes the polarization direction of components 1 and 2 before they enter the second output polarization beam displacer 12. The new x and y components are shown in the frame for location 12. After these components pass through the first output polarization beam displacer 12, the components are polarized along the y direction are moved to the bottom beam location and the components polarized along the x direction remain at the top beam positions as shown in the frame for location 13.

Four half-wave waveplates 26 are disposed intermediate the first output polarization beam displacer 12 and the second output polarization beam displacer 13, such that each of the four beams from the first polarization beam displacer 12 passes through one of the four half-wave waveplates 26. The orientations of the four half-wave waveplates 26 are shown in the frame 14. After the beams pass through the four half-wave waveplates 26, their polarization directions are shown in the frame 15. After these beams pass through the second output polarization displacer 13, component 1a′ moves to the top-right beam position to combine with component 2a′ and component 1b′ moves to the bottom-right beam position to combine with component 2b′. Thus, light from the four half-wave plates 26 passes through the second output polarization displacer 13 to form two composite output beams, as shown in frame 16. One of the two composite output beams may be considered to contain the even channels, while the other of the two composite output beams may be considered to contain the odd channels of the communication signals.

The interleaver shown in FIG. 1 is thus equivalent a conventional one-stage Solc-type interleaver having the fast axis of the birefringent crystal thereof oriented at 45° with respect to the polarization direction of light input thereto. The equivalent birefringent crystal orientation provided by the one-stage interleaver of FIG. 1 is determined by the orientation of the half-wave waveplates 21 and 22. Thus, various different birefringent crystal orientations can similarly be simulated by varying the orientation of the half-wave waveplates 21 and 22.

Further, a plurality of stages, wherein each stage corresponds to and simulates to a separate birefringent crystal having a unique angular orientation of a fast axis thereof, can be provided by providing a plurality of birefringent filter stages 11, wherein birefringent filter stage has a half-wave waveplate or the like at an input thereto so as to define the equivalent or simulated angular orientation corresponding to the angular orientation of a birefringent crystal. In this manner a plurality of stages, each stage having a unique angular orientation, can be provided so as to simulate a multi-crystal Solc birefringent filter (a multi-stage filter) having desired transmission characteristics.

Thus, according to the present invention, two output beams (1a′, 2a′) and (1b′, 2b′) are the two series of interleave channels and the phase delay Γ (Γ=L2π/λ), determines the channel spacing.

One important aspect of this invention is the ability to control the difference in optical path length between the first and second paths, so that the birefringence value provided by this difference in path length does not vary undesirably during operation of the invention, such as due to temperature changes.

As those skilled in the art will appreciate, the birefringence values of a device determine the operational characteristics, i.e., transmission, dispersion, phase distortion, thereof. Therefore, it is very important that the optical path length differences (and consequently the birefringence values) remain substantially fixed during operation of the devices.

Portions of the first and second paths, other than the portions which contribute the optical path length differences, are less critical since these other portions do not determined birefringence values. Generally, portions of the first and second paths, other than the portions which contribute to the optical path length differences, tend to vary (changes in physical length and/or changes in an index of refraction thereof) in response to environment (e.g., temperature) changes by approximately the same amount, due to structural similarity and symmetry of the first and second paths, and thus do not generally tend to change the optical path length difference. Therefore, it is that portion of the first and second paths (e.g., the L/2 or L portion shown in the figures) which directly provides the difference in optical path length that must be most carefully controlled.

According to the present invention, the difference in optical path length between the first and second paths may optionally be controlled by inserting a material having desired optical, thermal and/or mechanical properties into at least the longer of the two paths, so as to substantially fix the optical path length which defines the difference between the first and second paths. Thus, by inserting such a material into at least that portion of one path that defines optical path length difference (e.g., the L/2 portion or the L portion of the path shown in the figures), substantially more stable operation of the devices is achieved.

Optionally, according to the present invention, those portions of the first and second paths which do not contribute to the optical path length difference comprise air, vacuum or any other material. Of course, these portions of the first and second paths are inherently equal in physical lengths to one another (since they do not contribute to the optical path length difference).

According to the present invention, birefringence is obtained by optical path length differences, which may occur in free space, e.g., air or vacuum. A material of desired optical, thermal, and/or mechanical properties and having a desired index of refraction may be inserted along desired portion of the light paths of the present invention. For example, such a material may be utilized to shorten any desired path lengths and/or to provide a difference in optical path lengths to achieve a birefringent effect. For example, both paths can have the same physical dimensions, and birefringence may be obtained by inserting material having desired optical properties, e.g., an index of refraction greater than one, so as to cause the two paths to have different optical paths lengths. There are many advantages to the present invention as compared to conventional interleavers which utilize birefringent crystals. For example, the difference in optical path length can be manipulated so as to provided desired, comparatively high, birefringence values. An ultra low expansion (ULE) or fused silica may be utilized as a gasket in device construction, so as to obtain excellent temperature stability for the interleaver. Those skilled in the art will appreciate the various other materials having a very low thermal expansion coefficient are likewise suitable for use as such a gasket.

Further, the optical path lengths may be made so as to be variable, thus providing adjustability of the birefringence value and a tunable interleaver. The interleaver of the present invention is simple in construction and low in cost. Thus, the present invention overcomes many of the limitations associated with contemporary birefringent crystal interleavers, such as those limitations associated with the optical, physical, mechanical and thermal properties of birefringent crystals. Because the beam shift is symmetric in the apparatus, the polarization mode dispersion (PMD) is minimized.

As mentioned above, interleavers having multiple stages of birefringent effect may be used. As those skilled in the art will appreciate, such multi-stage interleavers provide enhanced passband and stopband characteristics.

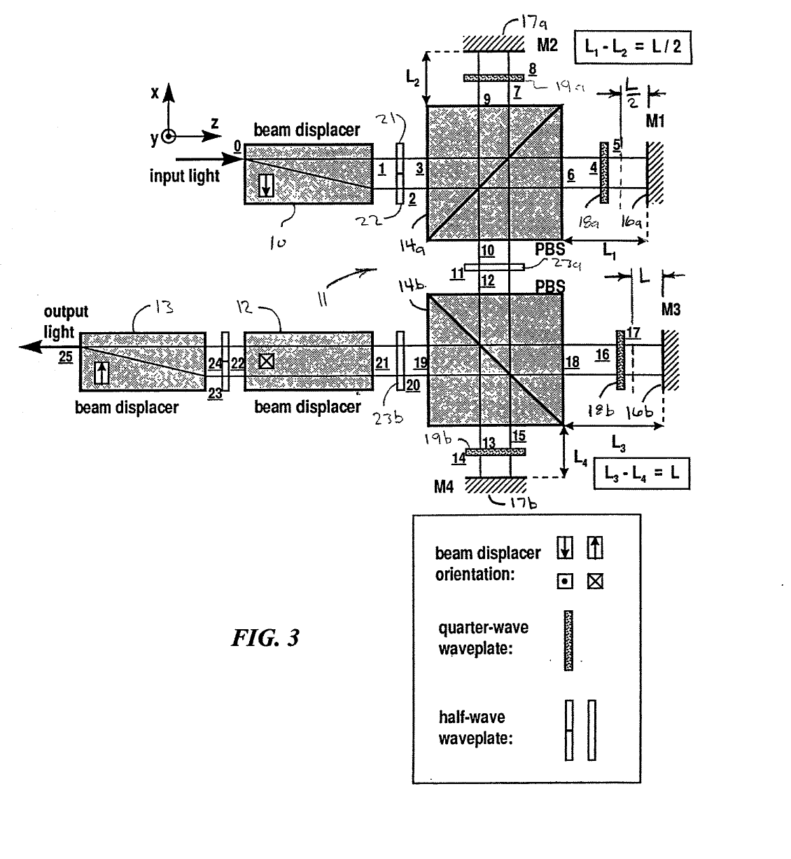

Referring now to FIG. 3, an interleaver having two stages of birefringent effect is shown schematically.

Referring now to FIG. 4, the optical beam states, the quarter-wave waveplate and the half-wave waveplate orientations at various locations are shown schematically. This interleaver corresponds to a SoIc filter having birefringent crystal orientations of 45° and −21° and phase delays of Γ and 2Γ, respectively for an exemplary interleaver shown in FIG. 3.

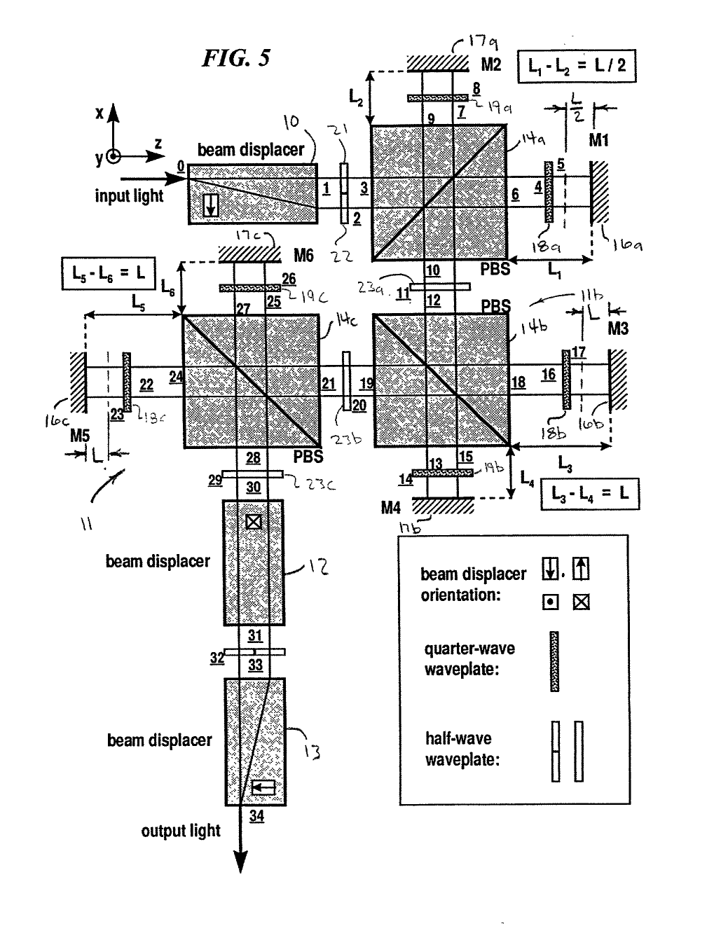

Referring now to FIG. 5, a multi-stage interleaver having three stages of birefringent effect is shown schematically. The phase delay in the second and third stages is twice as large as that for the first stage (Γ₁−L·2π/λ, Γ₂=Γ₃=2L·2π/λ. The interleaver channel spacing is determined by the phase delay in the first stage Γ₁.

Referring now to FIG. 6, the optical beam states, the quarter-wave waveplate and the half-wave waveplate orientations at various locations of an exemplary three-stage interleaver of FIG. 5 are shown, the interleaver being equivalent to a SoIc filter having birefringent crystal orientations of 45°, −21°, and 7° and having phase delays of Γ, 2Γ, and 2Γ, respectively.

It is important to appreciate that in each configuration of the present invention, some of the half-wave waveplates may be eliminated by rotating the beam displacer orientation accordingly.

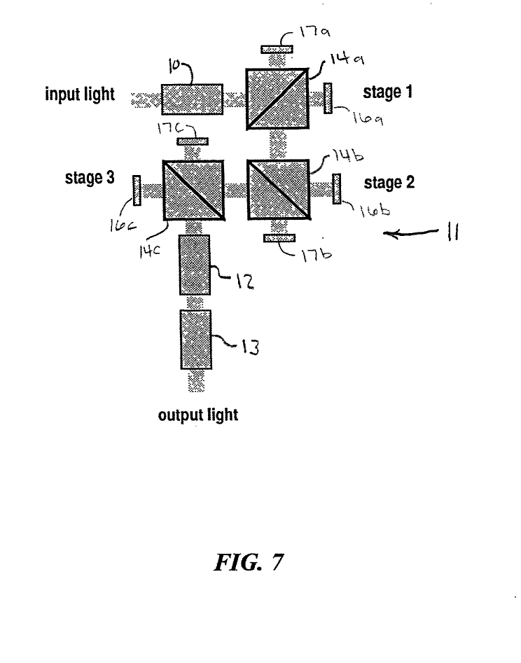

Referring now to FIG. 7, a parallel array of input beams (e.g., 2, 4, 8, 16, 256 or more channels may be configured so as to utilize the same interleaver. The use of such a parallel array of input beams is shown schematically in FIG. 7, wherein the wider beams indicate such a parallel array thereof. These input beams can be configured to a two-dimensional array, so as to facilitate high packaging density and low cost per channel.

It will therefore be appreciated that it is comparatively easy to expand the multi-stage interleaver of the present invention to have any desired number of stages so as to facilitate and enhance interleaver performance.

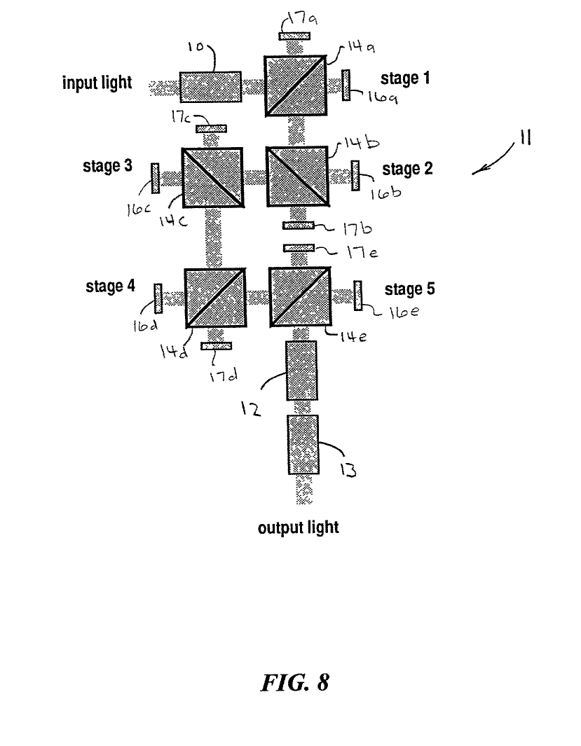

Referring now to FIG. 8, a five-stage interleaver configured to demultiplex a parallel array of beams simultaneously is shown schematically.

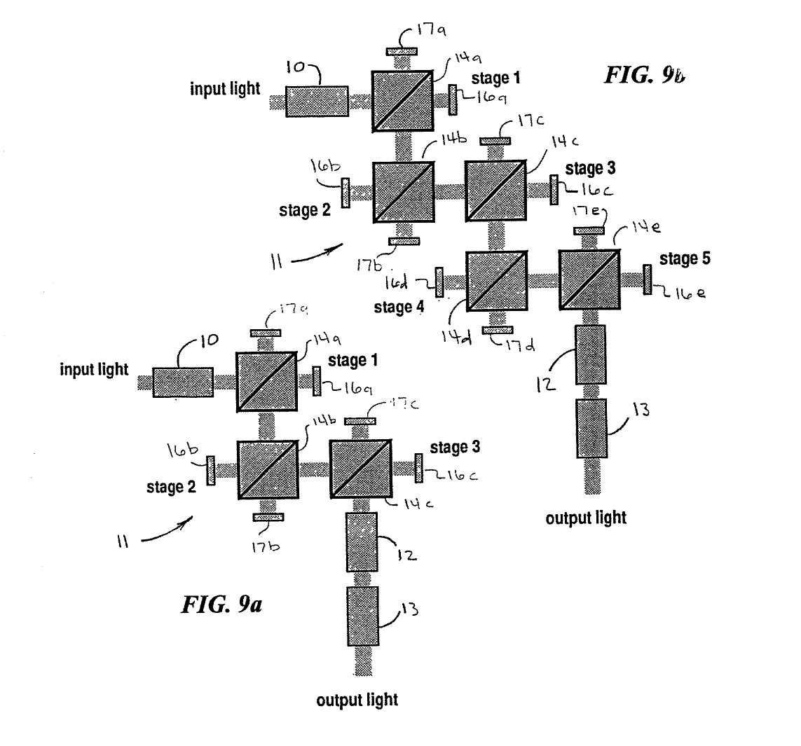

Referring now to FIG. 9a, an alternative layout for a three-stage interleaver is shown. This three-stage interleaver is configured to demultiplex an array of beams simultaneously.

Referring now to FIG. 9b, an alternative layout for a five-stage interleaver is shown. This five-stage interleaver is configured to demultiplex an array of beams simultaneously.

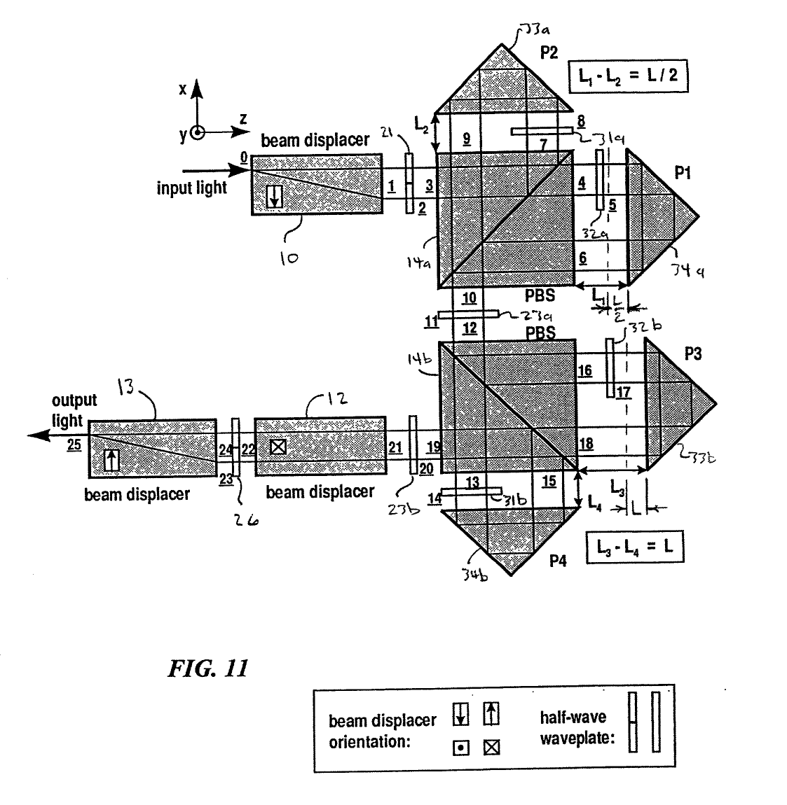

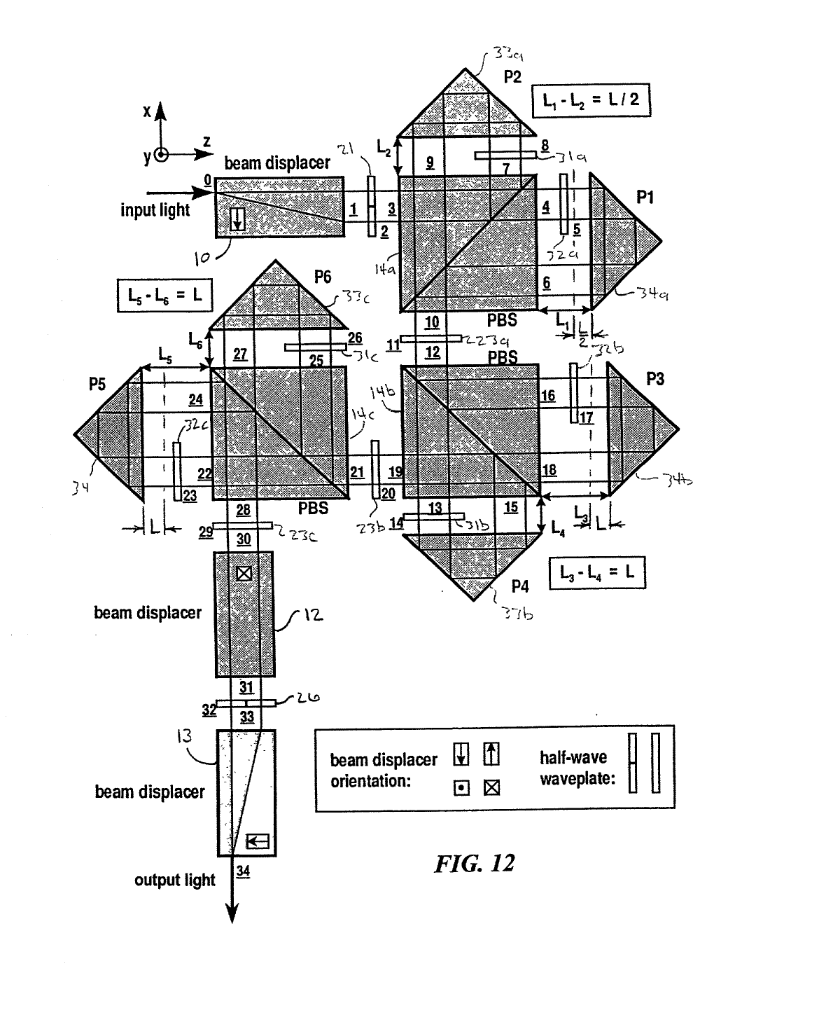

Referring now to FIGS. 10-12, an alternative embodiment of the interleaver of the present invention is shown schematically, wherein the quarter-wave waveplates and the etalons or mirrors are replaced by half-wave plates 31 and 32 and right-angle prisms 33 and 34. FIG. 10 shows a one-stage interleaver, FIG. 11 shows a two-stage interleaver, and FIG. 12 shows a three-stage interleaver.

One advantage of the birefringent filter configuration of FIGS. 10-12 is that feedback is minimized. Feedback occurs when the optical signal is transmitted back to the source, where the optical signal may undesirably interfere with operation of the source. Feedback can occur in the embodiments of the present invention depicted in FIGS. 1-9 (which utilized mirrors rather than prisms), since the light is reflected back to the same point within the polarization beam splitter where the light was originally split. This provides an opportunity for some portion of the light which should be reflected away from the split point to be undesirably transmitted back to the source. Thus, isolation apparatus should be implemented between the interleaver and the input source if the feedback causes undesirable interference to the input source. According to the embodiments of the present invention shown in FIGS. 10-12, which utilize prisms rather than mirrors, light from the prisms is directed back to a different point within each polarization beam splitter from where the light was originally split, such that any light which is transmitted through the polarization beam splitter, rather than reflected thereby, is not directed back to the source and undesirable feedback is thus mitigated. The corresponding optical beam states, waveplate orientations are the same as shown in FIG. 2 for an exemplary one-stage (45°, Γ) interleaver, FIG. 4 for an exemplary two-stage (45°, Γ; −21°, 2Γ) interleaver, and FIG. 6 for an exemplary three-stage (45°, Γ; −21°, 2Γ; 7°, 2Γ) interleaver, respectively.

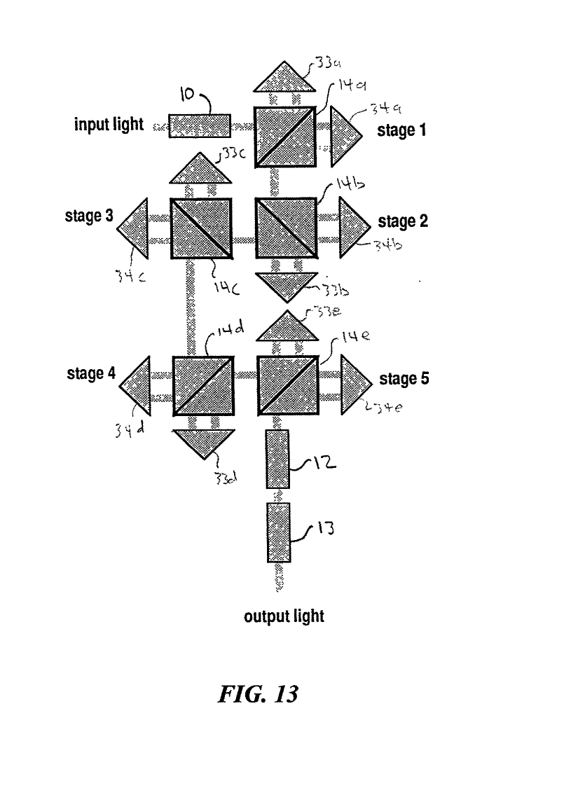

Referring now to FIG. 13, a five-stage interleaver utilizing half-wave waveplates and right angle prisms is shown. This five stage interleaver is configured to demultiplex an array of beams simultaneously.

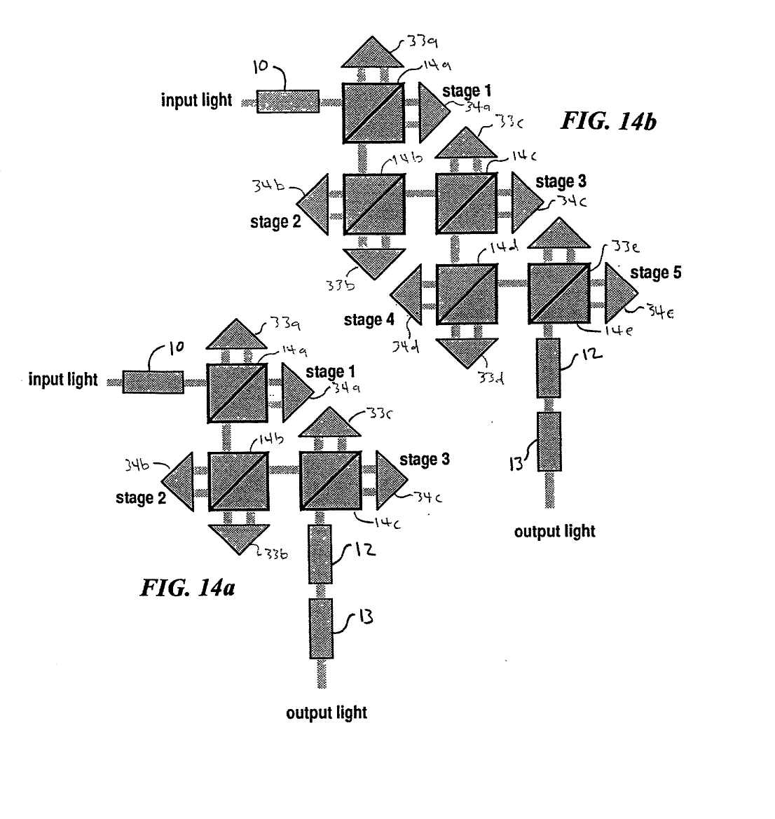

Referring now to FIG. 14a, an alternative layout for a three-stage interleaver utilizing half-wave waveplates and right angle prisms is shown. This three-stage interleaver is configured to demultiplex an array of beams simultaneously.

Referring now to FIG. 14b, an alternative layout for a five-stage interleaver utilizing half-wave waveplates and right angle prisms is shown. This five-stage interleaver is configured to demultiplex an array of beams simultaneously.

It is important to appreciate that, as mentioned above, the phase delay necessary for providing a birefringent effect may be obtained by inserting a material having desired optical, thermal, and/or mechanical properties into at least a portion of either the first or second path.

Although examples discussed above utilize equivalent birefringent filter element angles of 45°, −21° and −7° and utilize phase delays of Γ, 2Γ and 2Γ, those skilled in the art will appreciate that various other angles and phase delays are likewise suitable. For example, phase delays of Γ, 2Γ and Γ may alternatively be utilized.

The interleavers described herein are suitable for demultiplexing optical signals. Those skilled in the art will appreciate similar structures may be utilized to multiplex optical signals.

As those skilled in the art will appreciate, the waveplates which are utilized in the present invention can optionally be omitted in some instances by rotating subsequent components appropriately. Further, various devices and/or materials may alternatively be utilized to orient the polarization direction of light beams. For example, devices and/or materials which are responsive to applied voltages, currents, magnetic fields and/or electrical fields may be used to orient the polarization direction of light beams. Thus, the use of waveplates herein is by way of example only, and not by way of limitations.

Further, when waveplates having identical orientations are dispose next to one another, then a common waveplate may be substituted therefor.

As used herein, the term gasket is defined to include any bracket, mount, optical bench, host, enclosure or any other structure which is used to maintain components of the present invention in desired positions relative to one another. Preferably, such gasket is comprised of an ultra low expansion (ULE) material, fused silica or any other material having a very low thermal expansion coefficient.

It is understood that the exemplary interleavers described herein and shown in the drawings represent only presently preferred embodiments of the present invention. Indeed, various modifications and additions may be made to such embodiments without departing from the spirit and scope of the invention. Those skilled in the art will appreciate that various different means for defining the first and second paths, wherein each of the first and second paths have a different optical path length, are contemplated. Further, various different devices for separating the beams at each stage into separate components, such that each component can travel along a different path, are likewise contemplated. For example, rather than using polarization beam displacers to separate composite light beams into components thereof and/or to combine component light beams into corporate light beams, those skilled in the art will appreciate that polarization beam splitters, typically in cooperation with mirrors, may alternatively be utilized and are therefore considered equivalent to polarization beam displacer for the purpose of separating and recombining light beams. Thus, these and other modifications and additions may be obvious to those skilled in the art and may be implemented to adapt the present invention for the use of a variety of different applications.

1. An interleaver comprising:
an input polarization beam displacer;
a birefringent filter assembly in optical communication with the input polarization beam displacer, the birefringent filter assembly comprising at least one birefringent filter stage, each birefringent filter stage comprising:
a polarization beam splitter;
two reflectors;
a first output polarization beam displacer in optical communication with the birefringent filter assembly; and
a second output polarization beam displacer in optical communication with the first output polarization beam displacer.

2. The interleaver as recited in claim 1, wherein the two reflectors comprise mirrors.

3. The interleaver as recited in claim 1, wherein each birefringent filter stage further comprises a quarter-wave waveplate intermediate each reflector and the polarization beam splitter.

4. The interleaver as recited in claim 1, wherein each birefringent filter stage further comprises a quarter-wave waveplate disposed intermediate each reflector and the polarization beam splitter.

5. The interleaver as recited in claim 1, further comprising:
a first input half-wave waveplate disposed intermediate the input polarization beam displacer and the birefringent filter assembly and configured so as to transmit a non-displaced beam therethrough; and
a second input half-wave waveplate disposed intermediate the input polarization beam displacer and the birefringent filter assembly and configured so as to transmit a displaced beam therethrough.

6. The interleaver as recited in claim 1, further comprising:
a first input half-wave waveplate disposed intermediate the input polarization beam displacer and the birefringent filter assembly and configured so as to transmit a non-displaced beam therethrough; and
a second input half-wave waveplate disposed intermediate the input polarization beam displacer and the birefringent filter assembly and configured so as to transmit a displaced beam therethrough.

7. The interleaver as recited in claim 1, further comprising a half-wave waveplate configured to receive an output of each polarization beam splitter.

8. The interleaver as recited in claim 1, further comprising a half-wave waveplate configured to receive an output of a polarization beam splitter, the half-wave waveplate having an optical axis angle of approximately −22.5° with respect to the +x axis at that location.

9. The interleaver as recited in claim 1, further comprising:
a half-wave waveplate of a first stage thereof configured to receive an output of a polarization beam splitter, the half-wave waveplate having a optical axis angle of approximately −33° with respect to the +x axis at that location; and
a half-wave waveplate of a second stage thereof configured to receive an output of a polarization beam splitter, the half-wave waveplate having a optical axis angle of approximately 10.5° with respect to the +x axis at that location.

10. The interleaver as recited in claim 1, further comprising:
a half-wave waveplate of a first stage thereof configured to receive an output of a polarization beam splitter, the half-wave waveplate having a optical axis angle of approximately −33° with respect to the +x axis at that location;
a half-wave waveplate of a second stage thereof configured to receive an output of a polarization beam splitter, the half-wave waveplate having a optical axis angle of approximately 14° with respect to the +x axis at that location; and
a half-wave waveplate of a third stage thereof configured to receive an output of a polarization beam splitter, the half-wave waveplate having a optical axis angle of approximately −3.5° with respect to the +x axis at that location.

11. The interleaver as recited in claim 1, further comprising:
a first half-wave waveplate disposed intermediate the first output polarization beam displacer and the second output polarization beam displacer;
a second half-wave waveplate disposed intermediate the first output polarization beam displacer and the second output polarization beam displacer;
a third half-wave waveplate disposed intermediate the first output polarization beam displacer and the second output polarization beam displacer; and
a fourth half-wave waveplate disposed intermediate the first output polarization beam displacer and the second output polarization beam displacer.

12. The interleaver as recited in claim 1, further comprising:
a first half-wave waveplate disposed intermediate the first output polarization beam displacer and the third output polarization beam displacer, the first half-wave waveplate having an optic axis orientation of approximately 45°;
a second half-wave waveplate disposed intermediate the second output polarization beam displacer and the second output polarization beam displacer, the first half-wave waveplate having an optic axis orientation of approximately 90°;
a third half-wave waveplate disposed intermediate the first output polarization beam displacer and the second output polarization beam displacer, the third half-wave waveplate having an optic axis orientation of approximately 0°; and
a fourth half-wave waveplate disposed intermediate the first output polarization beam displacer and the second output polarization beam displacer, the fourth half-wave waveplate having an optic axis orientation of approximately 45°.

13. The interleaver as recited in claim 1, wherein the birefringent filter assembly comprises one birefringent filter stage.

14. The interleaver as recited in claim 1, wherein the birefringent filter assembly comprises a plurality of birefringent filter stages.

15. The interleaver as recited in claim 1, wherein the birefringent filter assembly comprises two birefringent filter stages.

16. The interleaver as recited in claim 1, wherein the birefringent filter assembly comprises three birefringent filter stages.

17. The interleaver as recited in claim 1, wherein the input polarization beam displacer, the birefringent filter assembly, the first output polarization beam displacer and the second output polarization beam displacer are configured so as to facilitate interleaving of a plurality of input beams simultaneously.

18. The interleaver as recited in claim 1, wherein the polarization beam splitter and the two reflectors for each birefringent filter stage define two light paths wherein a difference in the first and second optical path lengths is provided by a material having an index of refraction greater than one which is disposed within at least a portion of one of the first and second paths.

19. The interleaver as recited in claim 1, wherein the polarization beam splitter and the two reflectors for each birefringent filter stage define two light paths wherein an index of refraction is different for at least a portion of the first and second paths, so as to cause the first and second paths to have different optical lengths.

20. The interleaver as recited in claim 1, wherein the interleaved channels have spacing which is tunable.

21. An interleaver comprising:
a birefringent filter assembly coupled so as to receive at least two beams of polarized light; and
wherein the birefringent filter assembly is configured so as to provide a birefringent effect with respect to the beams without the use of birefringent crystals.

22. An interleaver comprising:
a birefringent filter assembly coupled so as to receive at least two beams of polarized light; and
wherein the birefringent filter assembly is configured so as to provide a birefringent effect with respect to the beams by causing the beams to travel along two paths, each path having a different optical path length.

23. The interleaver as recited in claim 22, wherein the difference in the first and second optical path lengths is provided by a material having an index of refraction greater than one which is disposed within at least a portion of one of the first and second paths.

24. An interleaver comprising:
an input beam separator;
a birefringent filter assembly in optical communication with the input beam separator, the birefringent filter assembly comprising at least one birefringent filter stage, each birefringent filter stage comprising:
a polarization beam splitter;
two reflectors; and
a polarization beam recombiner.

25. The interleaver as recited in claim 24, wherein;
the beam separator comprises a polarization beam displacer; and
the beam recombiner comprises two polarization beam displacers.

26. The interleaver as recited in claim 24, wherein:
the beam separator comprises a polarization beam splitter; and
the recombiner comprises at least one polarization beam splitter.

27. A method for interleaving, the method comprising:
separating a composite beam into two components thereof;
separating each of the two components into two sub-components and transmitting the two sub-components along two different paths, each of the two paths having a different optical path lengths with respect to one another;
recombining the sub-components of each component so as to achieve a birefringent effect;
separating the two components into sub-components thereof according to a polarization of each; and
recombining the sub-components so as to form two new composite beams, wherein each new composite beam contains substantially different channels with respect to the other new composite beam.

28. A method for interleaving, the method comprising:
separating a composite light beam into first and second orthogonally polarized components thereof;
separating the first component into first and second sub-components thereof and transmitting the first and second sub-components of the first component along two different paths, wherein each path has a different optical path length and recombining the first and second sub-components with one another so as to form a first component having a birefringent effect;
separating the second component into first and second sub-components thereof and transmitting the second and second sub-components of the second component along two different paths, wherein each path has a different optical path length and recombining the second and first sub-components with one another so as to form a second component having a birefringent effect;
separating the first component into orthogonally polarized first and second sub-components thereof;
separating the second component into orthogonally polarized first and second components thereof;
combining the first sub-component of the first component with the first sub-component of the second component, so as to form a first composite output beam; and
combining the second sub-component of the first component with the second sub-component of the second component, so as to form a second composite output beam.
